(19) United States
(12) Patent Application Publication
(10) Pub. No.: US 2025/0172041 A1
(43) Pub. Date: May 29, 2025

(54) LADDER SYSTEM WITH REMOVABLE TRAY

(71) Applicant: Dorel Home Furnishings, Inc., Wright City, MO (US)

(72) Inventors: Kyle J. Lawrence, Greenfield, IN (US); Eric W. Kruse, Seymour, IN (US); Evan A. Brown, Campbellsburg, IN (US); Troy L. Franks, Carmel, IN (US)

(21) Appl. No.: 19/026,205

(22) Filed: Jan. 16, 2025

Related U.S. Application Data
(63) Continuation of application No. 18/478,333, filed on Sep. 29, 2023.
(60) Provisional application No. 63/377,594, filed on Sep. 29, 2022.
(60) Provisional application No. 63/385,861, filed on Dec. 2, 2022.

(51) Int. Cl. E06C 7/14; E06C 1/32; E06C 7/02; E06C 7/42

(52) U.S. Cl. CPC E06C 7/14; E06C 1/32; E06C 7/02; E06C 7/423

(57) ABSTRACT

A ladder system includes a ladder, a tray, and a mode-independent attachment unit. The ladder is changeable between a step-ladder mode and a straight-ladder mode. The tray is configured to be attached to any step included in the ladder. The mode-independent attachment unit detachably couples the tray to any step.

### CROSS-REFERENCE TO RELATED APPLICATIONS

This application is a continuation of U.S. patent application Ser. No. 18/478,333, filed Sep. 29, 2023, which claims the benefit and priority, under 35 U.S.C. § 119 (e) and any other applicable laws or statues, to U.S. Provisional Patent Application No. 63/377,594 filed on Sep. 29, 2022, and to U.S. Provisional Patent Application No. 63/385,861 filed on Dec. 2, 2022, the entire disclosures of which are hereby expressly incorporated herein by reference.

### BACKGROUND

The present disclosure relates to a ladder, and particularly to a ladder with a removable tray. More particularly, the present disclosure relates to a ladder with a removable tray and a mode-independent attachment unit for coupling the removable tray to any of the steps of the ladder.

### SUMMARY

A ladder system in accordance with the present disclosure a ladder, a tray configured to be attached to any step of the ladder, and a mode-independent attachment unit coupled to the tray. The mode-independent attachment unit is operable to retain the tray on the step.

In illustrative embodiments, the ladder includes a first ladder unit, a second ladder unit, and a mode-changing hinge interconnecting the first ladder unit and the second ladder unit. The first ladder unit and the second ladder unit are each coupled to the mode-changing hinge for pivotable movement relative to one another about a hinge pivot axis to change the ladder from a step-ladder mode, in which the first ladder unit and the second ladder unit extend upwardly away from underlying ground and toward one another to form an included angle therebetween, and a straight-ladder mode, in which the first ladder unit and the second ladder unit are arranged along a substantially straight line such that one of the first ladder unit and the second ladder unit is supported above the underlying ground when the ladder is leaned against a structure. The tray is configured to be installed on any step of the ladder via the mode-independent attachment unit when the ladder is in the step-ladder mode or the straight-ladder mode.

In illustrative embodiments, the mode-independent attachment unit includes a hanger hook and a retainer latch both extending downwardly from the tray and configured to grip a step on which the tray is to be installed. The hanger hook and the retainer latch cooperate to apply a compressive load on the step so that the tray is retained in a fixed position to hold objects for a user standing on the ladder at an elevated position above ground. At least one of the hanger hook and the retainer latch is configured to move relative to the tray in response to a lifting force on the tray by the user to remove the tray from the step and relocate the tray to another step. Removal and installation of the tray to any step of the ladder is possible using only one arm of the user while the user's other arm remains available to support the user on the ladder at the elevated position.

### BRIEF DESCRIPTIONS OF THE DRAWINGS

The detailed description particularly refers to the accompanying figures in which:

FIG. 1 is a perspective view of a ladder system, in accordance with the present disclosure, including a ladder having a first ladder unit, a second ladder unit, and a mode-changing hinge interconnecting the first ladder unit and the second ladder unit, the first ladder unit and the second ladder unit being pivotably coupled with the mode-changing hinge to change the ladder from a step-ladder mode, as shown in FIG. 1, to a straight-ladder mode, as shown in FIG. 2, and further showing a tray included in the ladder system and attached to a step of the second ladder unit in a tray-use mode to support items for a user;

FIG. 2 is a perspective view of the ladder system of FIG. 1 showing the ladder in the straight-ladder mode in which the first ladder unit and the second ladder unit are arranged along a substantially straight line, and further showing that each of the first ladder unit and the second ladder unit includes a non-extendable ladder unit and an extendable ladder unit configured to slide relative to the non-extendable ladder unit to increase a height of at least one side of the ladder;

FIG. 3 is a side view of the ladder system of FIG. 1 showing that the ladder system includes a mode-independent attachment unit extending downwardly from the tray and configured to aid in attaching and removing the tray from the step, the mode-independent attachment unit having a hanger hook and a retainer latch that pivots as the tray is placed on the step;

FIG. 4 is an enlarged view of a portion of FIG. 1 showing the tray installed on a step of the ladder and including a tray base and a tray rim coupled to a perimeter of the tray base and extending upwardly from the tray base to block items placed on the tray base from falling off of the tray, and further showing that the tray base is formed to include raised pocket dividers to establish separate item pockets for the tray;

FIG. 5 is an enlarged perspective view of the tray of FIG. 4 removed from the ladder, showing that the tray rim includes a first side wall, a second side wall opposite the first side wall, a front wall interconnecting the first side wall and the second side wall, and a rear wall opposite the front wall;

FIG. 6 is a sectional view of the tray taken along line 6-6 in FIG. 5 showing that the hanger hook includes a hanger mount fixed to the tray, a hanger body extending downwardly from the hanger mount, and a hanger point facing toward the retainer latch, and further showing that the retainer latch includes a latch connector, a latch body coupled with and extending downwardly from the latch connector, and a retainer tip facing toward the hanger hook, the latch body and the retainer tip being configured to pivot away from the hanger hook during installation and removal of the tray from the step;

FIG. 7 is a sectional view of the tray of FIG. 5 during installation onto the step showing the step is formed to include four catches at opposing corners of the step, and further showing that in response to downward movement of the tray toward the step, the latch body of the retainer latch engages one of the catches to cause pivotable movement of the retainer latch away from the hanger hook so that the retainer latch has clearance to pass over the catch as a front end of the tray is lowered to an installed position as shown in FIG. 8;

FIG. 8 is a sectional view of the tray of FIG. 5 after installation onto the step showing that the hanger body of the hanger hook engages one of the catches and the latch body of the retainer latch engages another one of the catches, and further suggesting that after the retainer latch passes over the catch, the retainer latch pivots toward the hanger hook to retain the tray on the step;

FIG. 9 is an enlarged view of the ladder system of FIG. 1 showing the tray in a tray-storage mode in which the tray is arranged between two neighboring steps and resides within a width of the ladder to minimize a total width of the ladder system for storage;

FIG. 10 is a sectional view of FIG. 9 showing that the first rung mount and the second rung mount are formed as hooks extending from the first side will and the second side wall of the tray rim, respectively, and at least one of the first rung mount and the second rung mount wrap at least partially around a catch of a step to releasably attach the tray between two neighboring steps;

FIG. 11 is a perspective view of the ladder system of FIG. 1 showing a paint tray coupled to the tray of the ladder system, the paint tray having attachment hooks that extend into tray attachment slots formed in the rear wall of the tray rim;

FIG. 12 is a perspective view of a second embodiment of a ladder system, in accordance with the present disclosure, including a ladder having a first ladder unit, a second ladder unit, and a mode-changing hinge interconnecting the first ladder unit and the second ladder unit, the first ladder unit and the second ladder unit being pivotably coupled with the mode-changing hinge to change the ladder from a step-ladder mode to a straight-ladder mode, and further showing a tray attached to a step of the first ladder unit in a tray-use mode to support items for a user;

FIG. 13 is an enlarged view of the tray of FIG. 12 showing that the tray includes a tray base and a tray rim coupled to a perimeter of the tray base and extending upwardly from the tray base to ensure that items placed on the tray base do not fall off of the tray, the tray base is formed to include raised pocket dividers to establish separate item pockets for the tray, and further showing that the tray rim includes a first side wall, a second side wall opposite the first side wall, a front wall interconnecting the first side wall and the second side wall, and a rear wall opposite the front wall and formed to include a pair of tray attachment slots;

FIG. 14 is a perspective view of the ladder system of FIG. 12 in a storage mode showing that the first and second ladder units are adjustable about the horizontal hinge pivot axis to place the ladder in the storage mode in which the first and second ladder units lie in side-by-side and substantially parallel relation to one another, and further showing that the tray is arranged between two neighboring steps in the tray-storage mode to minimize a total width of the ladder system;

FIG. 15 is a sectional view of the ladder system of FIG. 12 with the tray in tray-storage mode showing that each step is formed to include three catches at opposing corners of the step and each catch is formed to include at least one notch, and further showing that the tray includes a first rung mount coupled to and extending away from the first side wall of the tray rim and a second rung mount coupled to and extending away from the second side wall of the tray rim, the first rung mount and the second rung mount extending into a corresponding notch;

FIG. 16 is an enlarged view of a portion of FIG. 15 showing the first rung mount of the tray extending into the notch formed in the step to retain the tray to the ladder in the tray-storage mode, and further showing that the first rung mount is formed as a rib extending outwardly from the first side wall of the tray rim;

FIG. 17 is an enlarged view of a portion of FIG. 15 showing the second rung mount of the tray extending into the notch formed in the step to retain the tray to the ladder in the tray-storage mode, and further showing that the second rung mount is formed as a rib extending outwardly from the second side wall of the tray rim;

FIG. 18 is a sectional view of a portion of the ladder system of FIG. 12 showing that the ladder system includes a mode-independent attachment unit extending downwardly from the tray and having a hanger hook and a retainer latch configured to pivot as the tray is installed on the step, and further showing that the hanger hook and the retainer latch both engage corresponding catches of the step to retain the tray on the step;

FIG. 19 is a perspective view of the retainer latch of FIG. 18 showing that the retainer latch includes a latch connector, a latch body coupled with and extending downwardly from the latch connector, and a retainer tip facing toward the hanger hook, the latch body and the retainer tip being in a normally locked positon, as shown in FIGS. 19 and 20, and configured to pivot away from the hanger hook during installation and removal of the tray from the step to a release position, as shown in FIG. 21;

FIG. 20 is a side view of the retainer latch of FIG. 19 showing the retainer latch in the normally locked position in which the retainer latch is urged toward the hanger hook by as bias member;

FIG. 21 is a side view of the retainer latch of FIG. 19 showing the retainer latch in the release position in which the retainer latch pivots away from the hanger hook as the retainer latch contacts a corresponding catch of the step so that the retainer latch pivots and can move past the catch of the step;

FIG. 22 is a front view of the ladder system of FIG. 12 showing a paint tray coupled to the tray, the paint tray having attachment hooks that extend downwardly into the tray attachment slots formed in the rear wall of the tray rim;

FIG. 23 is a perspective view of an alternative ladder system in accordance with the present disclosure showing the ladder of FIG. 12 and an alternative tray attached to the step in a tray-use mode to support items for a user and an alternative mode-independent attachment unit configured to detachably couple the tray to a step;

FIG. 24 is a perspective view of the ladder system of FIG. 23 showing that the first ladder unit pivots so that the ladder can change from the step-ladder mode, as shown in FIG. 23, to the straight-ladder mode, as shown in FIG. 24;

FIG. 25 is an enlarged view of the tray of FIG. 23 coupled with the step, showing that the tray includes a tray base and a tray rim coupled to a perimeter of the tray base and extending upwardly from the tray base to ensure that items placed on the tray base do not fall off of the tray;

FIG. 26 is side view of the tray of FIG. 25 removed from the step, showing that the mode-independent attachment unit extends downwardly from the tray and has a hanger hook and a retainer latch configured to slide relative to the tray and the hanger hook as the tray is installed on and removed from the step;

FIG. 27 is a perspective view of the tray of FIG. 25 showing that the tray rim includes an inner side wall, an outer side wall, and a top wall interconnecting upper ends of the inner side wall and the outer side wall, and an interior cavity is formed between the inner side wall and the outer side wall to receive a portion of the retainer latch and a portion of the hanger hook therein;

FIG. 28 is a sectional view of the ladder system of FIG. 27 showing that the retainer latch includes a latch body, a latch connector coupled to a spring, and a retainer tip, the spring is configured to move the latch body and the retainer tip away from the hanger hook during installation and removal of the tray from the step, and further showing that a hanger point of the hanger hook extends into a corresponding notch formed in the step to aid in retention of the tray to the ladder;

FIG. 29A is a sequential view of the tray of FIG. 23 being placed on the step through downward movement of the tray onto the step of the ladder, showing that the retainer latch contacts one of the catches of the step to cause the retainer latch is slide away from the hanger hook to a release position so that the retainer latch has clearance to pass over the catch;

FIG. 29B is another sequential view of the tray being placed on the step, showing that after the retainer latch passes over the widest portion of the catch, the retainer latch is urged toward the hanger hook by the spring;

FIG. 29C is another sequential view of the tray being placed on the step, showing that the hanger point of the hanger hook extends into a corresponding notch formed in the step to aid in retention of the tray to the ladder; and

FIG. 29D is another sequential view of the tray being placed on the step, showing that the retainer latch engages the catch after the tray is installed on the step and the retainer latch is biased to the normally locked positon.

### DETAILED DESCRIPTION

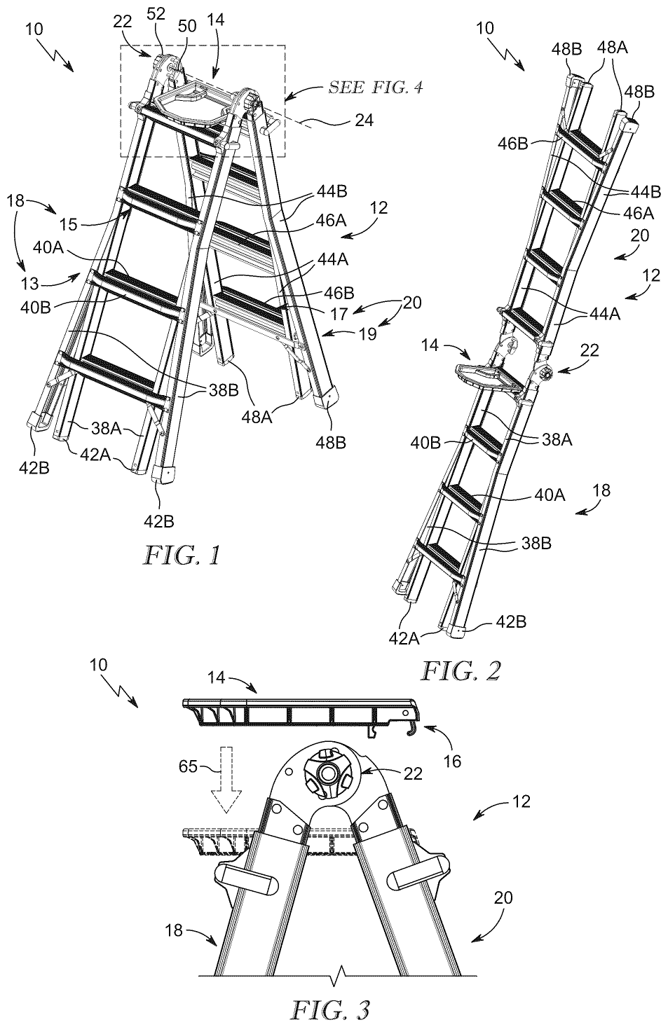

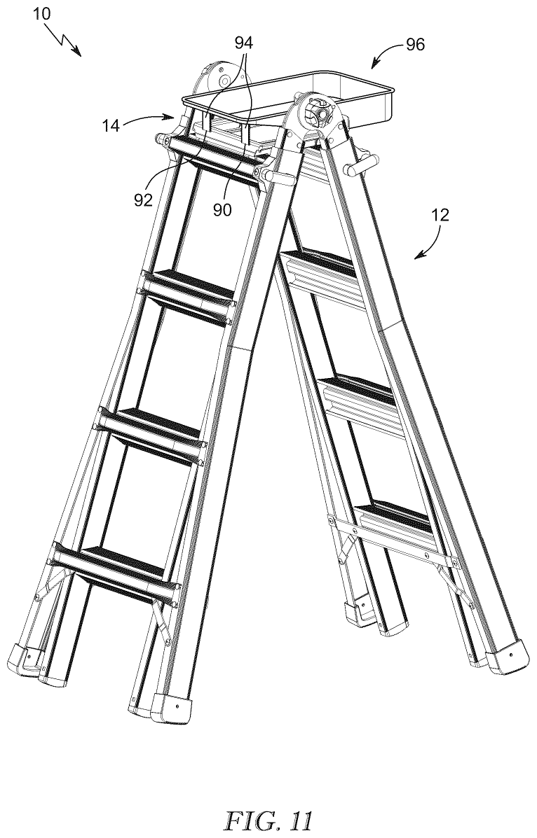

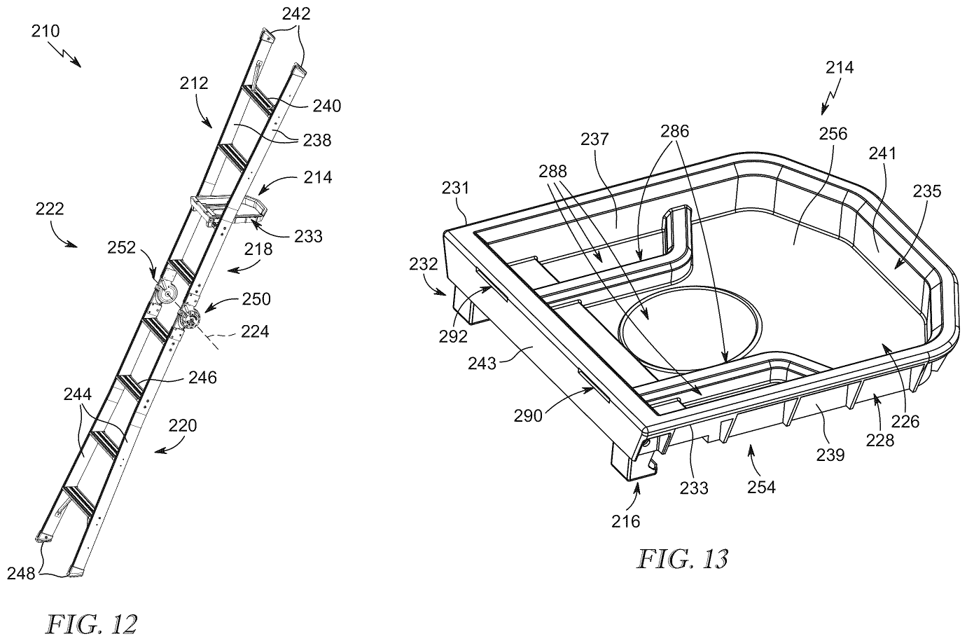

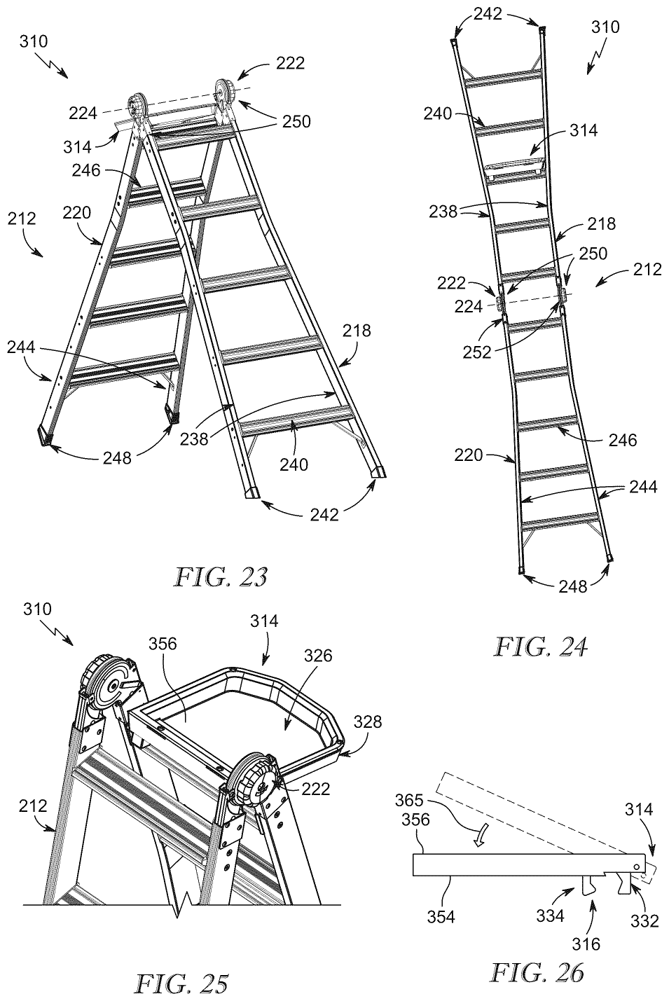

A ladder system 10, in accordance with the present disclosure, includes a ladder 12 that can be changed by a user in the field from a step-ladder mode, as shown in FIG. 1, to a straight-ladder mode, as shown in FIG. 2. Portions of ladder 12 can also be extended to adjust a height of the ladder in the step-ladder mode and the straight-ladder mode. The ladder system 10 further includes a tray 14 and a mode-independent attachment unit 16 integrated into the tray 14 and which allows the tray 14 to be removably attached to any step included in the ladder 12 irrespective of the configuration of the ladder 12. A first embodiment of ladder system 10 is shown in FIGS. 1-11. A second embodiment of a ladder system 210, in accordance with the present disclosure, is shown in FIGS. 12-22. A third embodiment of a ladder system 310, in accordance with the present disclosure, is shown in FIGS. 23-29D.

Ladder system 10 includes ladder 12, tray 14, and mode-independent attachment unit 16 as shown in FIG. 3. Ladder 12 is configured to support the user above underlying ground so that the user can reach higher areas. Tray 14 is configured to attach to ladder 12 and may be used to support items for the user while the user climbs ladder 12 and accesses the higher areas. Mode-independent attachment unit 16 is configured to mount tray 14 to ladder 12 and allows for one handed removal and installation of tray 14 so that the user can maintain support on ladder 12 with their other hand while climbing ladder 12 and repositioning tray 14 on any step of the ladder 12.

Ladder 12 includes a first ladder unit 18, a second ladder unit 20, and a mode-changing hinge 22 as shown in FIGS. 1 and 2. First ladder unit 18 is coupled to mode-changing hinge 22 and extends away from mode-changing hinge 22 in a first direction. Second ladder unit 20 is coupled to mode-changing hinge 22 and extends away from mode-changing hinge 22 in a second direction different than the first direction. Mode-changing hinge 22 interconnects first ladder unit 18 and second ladder unit 20 and provides a horizontal hinge pivot axis 24 to allow an angle between first ladder unit 18 and second ladder unit 20 to be adjusted.

First and second ladder units 18, 20 each include a non-extendable ladder unit 13, 17 and an extendable ladder unit 15, 19 as shown in FIGS. 1 and 2. Each non-extendable ladder unit 13, 17 is coupled to mode-changing hinge 22 and remains fixed in length relative to mode-changing hinge 22. Each extendable ladder unit 15, 19 is configured to slide relative to the respective non-extendable ladder unit 13, 17 toward and away from mode-changing hinge 22. Each extendable ladder unit 15, 19 allows the user to adjust a length of first and second ladder units 18, 20 from a retracted configuration, as shown in FIGS. 1 and 2, to an extended configuration. In the extended configuration, a height of first ladder unit 18 and/or second ladder unit 20 is increased so that the user can reach even higher areas or so the user can use ladder 12 on stairs, for example.

Each non-extendable ladder unit 13, 17 includes a first set of ladder supports 38A, 44A a first plurality of steps 40A, 46A and a first pair of braces 42A, 48A as shown in FIG. 1. Ladder supports 38A, 44A are coupled to mode-changing hinge 22. Ladder supports 38A, 44A are substantially parallel to one another along an entirety of a height of ladder supports 38A, 44A and are interconnected by first plurality of steps 40A, 46A. First plurality of steps 40A, 46A are configured to support the user while the user climbs ladder 12 and are configured to support tray 14 while tray 14 is in use on ladder 12. Depending on the configuration of ladder 12, braces 42A, 48A support ladder 12 using either the underlying ground or an external surface.

Each extendable ladder unit 15, 19 includes a second set of ladder supports 38B, 44B a second plurality of steps 40B, 46B and a second pair of braces 42B, 48B as shown in FIG. 1. Ladder supports 38B, 44B are C-shaped so that each ladder support 38B, 44B wraps partially around a corresponding ladder support 38A, 44A of first set of ladder supports 38A, 44A. Ladder supports 38B, 44A are interconnected by second plurality of steps 40B, 46B. Second plurality of steps 40B, 46B are configured to support the user while the user climbs ladder 12. Braces 42B, 48B support ladder 12 using either the underlying ground or an external surface.

Second set of ladder supports 38B, 44B are coupled to first set of ladder supports 38A, 44A for slidable movement relative to first set of ladder supports 38A, 44A as suggested in FIG. 1. A top portion of ladder supports 38B, 48B near mode-changing hinge 22 are substantially parallel to one another. A bottom portion of ladder supports 38B, 48B extend outwardly away from first set of ladder supports 38A, 44A so that the bottom portion of ladder supports 38B, 48B are not parallel to one another.

Second plurality of steps 40B, 46B are arranged in front of first plurality of steps 40A, 46A near the user as shown in FIGS. 1 and 2. Depending on the mode of first and second ladder units 18, 20, steps 40A, 40B, 46A, 46B may be arranged adjacent to one another so as to form a substantially flat surface for the user to stand on as shown in FIG. 1. Steps 40A, 40B, 46A, 46B may be offset from one another along the height of first and second ladder unit 18, 20 in response to first ladder unit 18 or second ladder unit 20 being changed to the extended configuration as steps 40B, 46B slide with ladder supports 38B, 44B. In the retracted configuration, braces 42A, 48A of non-extendable ladder unit 13, 17 and braces 42B, 48B of extendable ladder unit 15, 19 engage the underlying ground as shown in FIG. 1. To change first ladder unit 18 or second ladder unit 20 to the extended configuration, the user slides second set of ladder supports 38B, 44B downwardly. Because steps 40B, 46B are coupled with ladder supports 38B, 44B steps 40B, 46B slide with ladder supports 38B, 44B. In the extended configuration, braces 42A, 48A of non-extendable ladder unit 13, 17 are located above the underlying ground and braces 42B, 48B of extendable ladder unit 15, 19 engage the underlying ground. As compared to the retracted configuration, the height of first ladder unit 18 or second ladder unit 20 in the extended configuration is greater.

Mode-changing hinge 22 includes a pair of first connectors 50 and a pair of second connectors 52 as shown in FIG. 1. First connectors 50 couple ladder supports 38A to mode-changing hinge 22 while second connectors 52 couple ladder supports 44A to mode-changing hinge 22. First and second connectors 50, 52 allow first ladder unit 18 and second ladder unit 20 to be adjusted about horizontal hinge pivot axis 24 to change ladder 12 between a step-ladder mode, as shown in FIG. 1, and a straight-ladder mode, as shown in FIG. 2.

In the step-ladder mode, first ladder unit 18 and second ladder unit 20 extend upwardly away from the underlying ground and toward one another to form an included angle therebetween as shown in FIG. 1. Ladder 12 is self-supported in step-ladder mode using at least braces 42B, 48B which both engage the underlying ground to support ladder 12 above the underlying ground. In the straight-ladder mode, first ladder unit 18 and second ladder unit 20 are arranged along a substantially straight line such that one of first ladder unit 18 and second ladder unit 20 is supported above the other and underlying ground when the ladder 12 is leaned against an external structure. Ladder 12 is supported partially by the structure in straight-ladder mode by planting at least one of braces 42B, 48B on the underlying ground while the other leans against the structure. First and second ladder units 18, 20 are also adjustable about horizontal hinge pivot axis 24 to place the ladder 12 in a storage mode in which first and second ladder units 18, 20 are arranged to lie in side-by-side and substantially parallel relation to one another. Mode-changing hinge 22 further includes a lock (not shown) to block selective movement of first connectors 50 relative to second connectors 52 so that ladder 12 maintains step-ladder mode, straight-ladder mode, or storage mode.

First ladder unit 18 and second ladder unit 20 may be changed to the extended configuration at the same time or only one of first ladder unit 18 and second ladder unit 20 may be changed to the extended configuration. For example, one or both of first ladder unit 18 and second ladder unit 20 may be changed to the extended configuration while ladder 12 is in the step-ladder mode. One or both of first ladder unit 18 and second ladder unit 20 may be changed to the extended configuration while ladder 12 is in the straight-ladder mode.

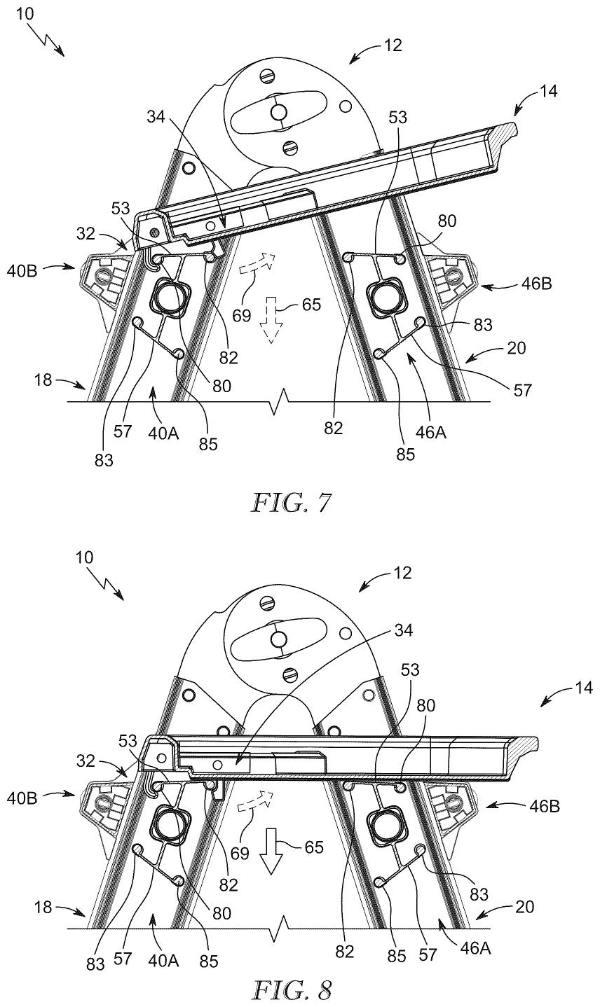

First plurality of steps 40A of first ladder unit 18 and first plurality of steps 46A of second ladder unit 20 have the same shape as one another as shown in FIGS. 7 and 8. Steps 40A, 46A have an I-shaped cross section. Second plurality of steps 40B and second plurality of steps 46B have the same shape as one another as shown in FIGS. 7 and 8. The shape of steps 40B, 46B is different than the shape of steps 40A, 46A.

Each of the first plurality of steps 40A, 46A includes a first surface 53 and a second surface 57 opposite the first surface 53 as shown in FIGS. 7, 8, and 10. The user may stand on either of first surface 53 and second surface 57 depending on the mode of ladder 12. For example, while ladder 12 is in the step-ladder mode, the user may stand on first surface 53 of step 40A, 46A. While ladder 12 is in straight-ladder mode, the user may stand on second surface 57 of step 40A, 46A.

First surface 53 is formed to include a first catch 80 and a second catch 82 on opposing ends of first surface 53 as shown in FIGS. 7 and 8. Second surface 57 is formed to include a third catch 83 and a fourth catch 85 on opposing ends of second surface 57. The I-shaped cross section of steps 40A, 46A provides the four catches 80, 82, 83, 85 at each point of the I-shaped cross section. In the illustrative embodiments, catches 80, 82, 83, 85 extend along an entirety of a length of steps 40A, 46A. In illustrative embodiments, catches 80, 82, 83, 85 are formed as protrusions that extend toward the surface 53, 57 opposite the surface 53, 57 on which the catch 80, 82, 83, 85 is formed. For example, first catch 80 is formed as a protrusion extending downwardly from first surface 53 toward second surface 57.

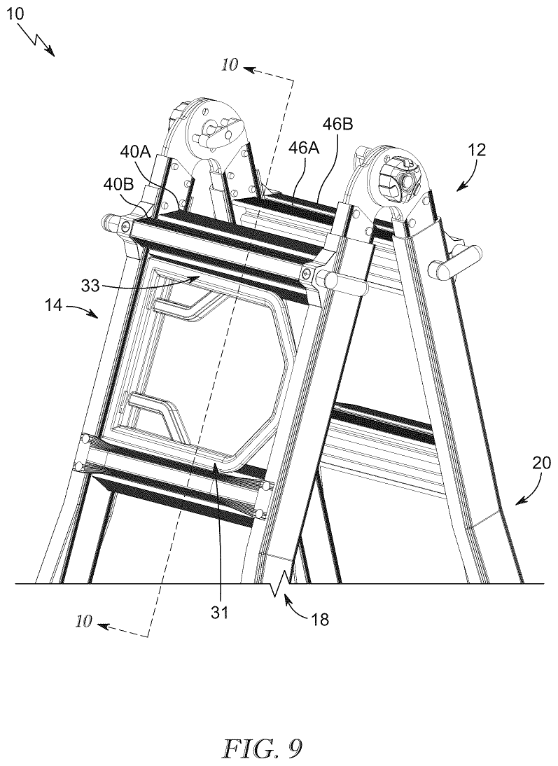

Tray 14 is configured to be attached to first ladder unit 18 or second ladder unit 20 such that tray 14 may be used by the user while ladder 12 is in either step-ladder mode, as shown in FIG. 1, or straight-ladder mode, as shown in FIG. 2. Tray 14 may extend forwardly or rearwardly on ladder 12. Tray 14 may also be attached to first ladder unit 18 or second ladder unit 20 while ladder 12 is in storage mode to achieve a tray-storage mode. In tray-storage mode, tray 14 may lie along a plane that is substantially parallel to both first and second ladder units 18, 20 so as to minimize a total width of ladder system 10 in storage mode as shown in FIG. 9. Tray 14 may also lie in tray-storage mode while tray 14 is not in use by the user, but while ladder 12 is in use.

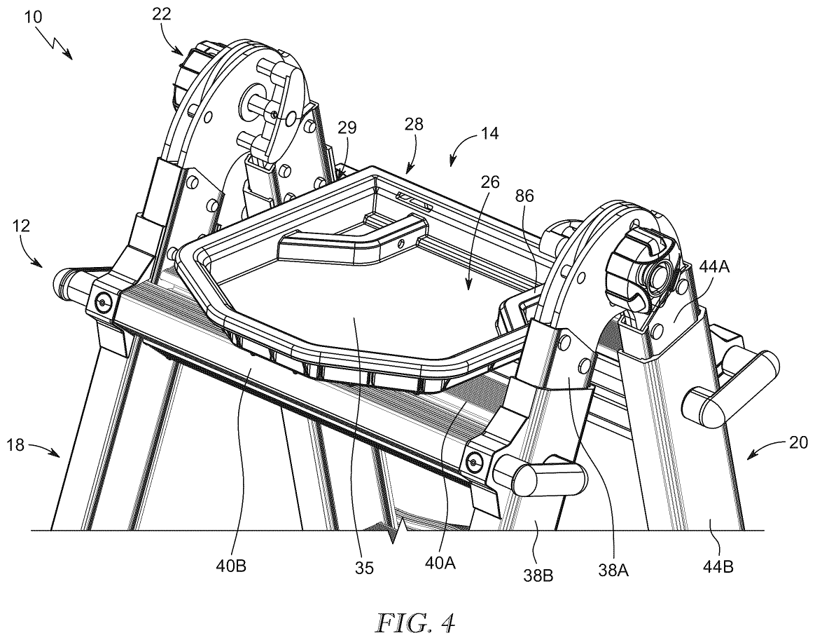

Tray 14 is configured to mount to steps 40A, 46A of ladder 12 and includes a tray base 26, a tray rim 28, and a tray storage mount 29 as shown in FIGS. 4-6. Tray base 26 is arranged to lie substantially horizontally while attached to step 40A, 46A and is configured to support items for the user. Tray rim 28 is coupled to a perimeter of tray base 26 and extends upwardly from tray base 26 to ensure that items placed on tray base 26 do not fall off of tray 14. Tray storage mount 29 allows tray 14 to be attached releasably between two neighboring steps 40A, 46A in the tray-storage mode as shown in FIG. 9.

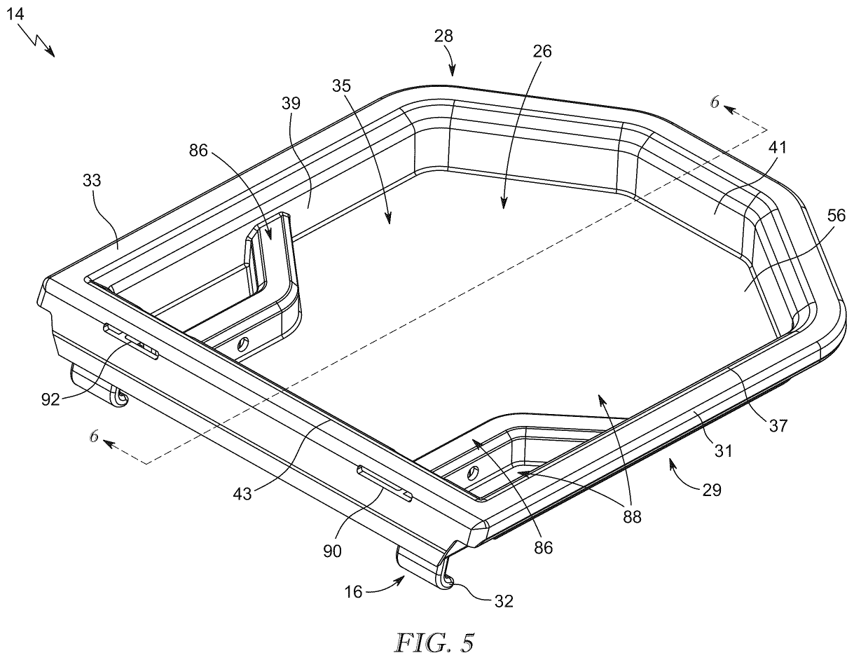

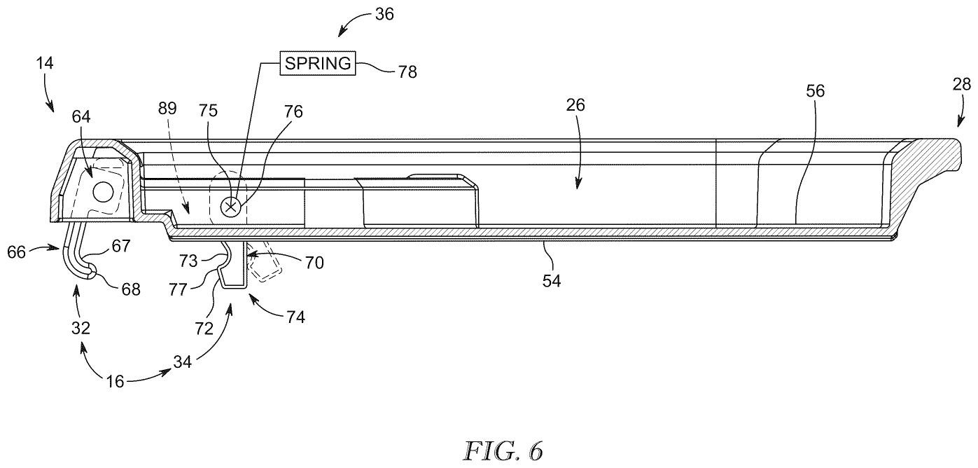

Tray base 26 includes an underside 54 and a topside 56 as shown in FIG. 6. Underside 54 of tray base 26 interfaces with the steps 40A, 46A when tray 14 is placed on ladder 12, regardless of whether tray 14 extends forwardly or rearwardly relative to ladder 12. Topside 56 is configured to engage and support items placed on tray 14. Tray base 26 is formed to include one or more raised pocket dividers 86 as shown in FIG. 5. The pocket dividers 86 are configured to establish a plurality of separate item pockets 88 that can each be used to hold and separate different items.

Tray rim 28 is sized to maximize a volume of an item-holding area 35 provided by tray 14 and to correspond to the shape and size of steps 40A, 46A and ladder supports 38A, 44A as shown in FIG. 4. Tray rim 28 includes first and second side walls 37, 39 and front and rear walls 41, 43 as shown in FIG. 5. A width of tray 14 is defined between first and second side walls 37, 39 and is sized to correspond to spacing between two neighboring steps 40A, 46A as shown in FIG. 9. Likewise, a length of tray 14 is defined by front and rear walls 41, 43 and is sized to correspond to spacing between ladder supports 38A, 44A as shown in FIG. 9. In this way, tray 14 resides in a space located vertically between two steps 40A, 46A and laterally between ladder supports 38A, 44A in the tray-storage mode. Tray 14 does not protrude outwardly beyond the space in any direction in the tray-storage mode as shown in FIG. 9.

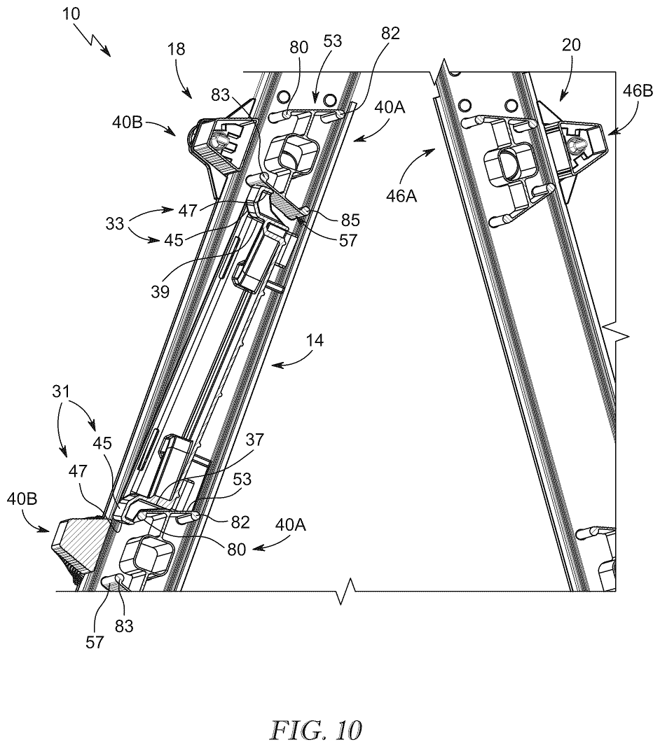

Tray storage mount 29 includes a first rung mount 31 coupled to first side wall 37 of tray rim 28 and a second rung mount 33 coupled to a second side wall 39 of tray rim 28 as shown in FIGS. 5 and 10. First and second rung mounts 31, 33 are illustratively embodied as hooks that extend outwardly away from tray rim 28 and longitudinally along at least a portion of a length of each respective side wall 37, 39 of tray rim 28. At least one of first and second rung mounts 31, 33 wraps at least partially around a corresponding catch 80, 82, 83, 85 of steps 40A, 46A in the tray-storage mode as shown in FIG. 10. For example, as shown in FIG. 10, tray 14 is stored on first ladder unit 18 between neighboring steps 40A. First rung mount 31 is wrapped at least partially around first catch 80 of step 40A to temporarily retain tray 14 to ladder 12 in the tray-storage mode.

First rung mount 31 and second rung mount 33 are both formed to include a top wall 45 and an outer wall 47 as shown in FIG. 10. Top wall 45 is coupled with and extends away from the corresponding side wall 37, 39. Outer wall 47 is coupled with the top wall 45 and extends downwardly away from top wall 45 in spaced apart relation to side wall 37, 39. Outer wall 47 has a height that is less than a height of side wall 37, 39 to provide the illustrative hook that wraps at least partially around a corresponding catch 80, 82, 83, 85 of steps 40A, 46A in the tray-storage mode. First and second rung mounts 31, 33 may wrap at least partially around any catch 80, 82, 83, 85 depending on the mode of ladder 12.

While tray 14 is in the tray-storage mode, steps 40B, 46B are free to slide over tray 14 as suggested in FIG. 10. For example, as shown in FIG. 10, step 40B is free to slide over tray 14 such that second set of ladder supports 38B may slide relative to first set of ladder supports 38A to change first ladder unit 18 to the extended configuration.

Similarly, while tray 14 is in use and coupled to step 40A, step 40B is free to slide over tray 14 such that second set of ladder supports 38B may slide relative to first set of ladder supports 38A to change first ladder unit 18 to the extended configuration. When tray is in use and coupled to step 46A, step 46B is free to slide over tray 14 such that first set of ladder supports 44B may slide relative to first set of ladder supports 44A to change second ladder unit 20 to the extended configuration.

Rear wall 43 of tray rim 28 is formed to include a pair of tray attachment slots 90, 92 as shown in FIGS. 5 and 11. Tray attachment slots 90, 92 are configured to receive attachment hooks 94 included in a paint tray 96. Paint tray 96 may be included in ladder system 10.

Mode-independent attachment unit 16 is configured to provide a compressive load on a step 40A, 46A included in first and second ladder units 18, 20 to block movement of tray 14 relative to ladder 12. Mode-independent attachment unit 16 includes a hanger hook 32, a retainer latch 34, and biasing means 36 as shown in FIG. 6. Hanger hook 32 is fixed to tray 14 and engages first ladder unit 18 or second ladder unit 20 while tray 14 is in use. Retainer latch 34 is coupled to tray 14 and movable relative to hanger hook 32 and tray 14. Biasing means 36, as shown in FIG. 6, is coupled to retainer latch 34 and urges retainer latch 34 toward hanger hook 32 so that the compressive load is provided on step 40A, 46A by and between hanger hook 32 and retainer latch 34. In the illustrative embodiment, mode-independent attachment unit 16 includes a pair of hanger hooks 32 and a pair of retainer latches 34. Though, a single hanger hook 32 and a single retainer latch 34 is contemplated.

Hanger hook 32 includes a hanger mount 64, a hanger body 66, and a hanger point 68 as shown in FIG. 6. Hanger mount 64 is coupled to at least one of tray base 26 and tray rim 28. Hanger body 66 extends downwardly from hanger mount 64 and toward retainer latch 34 to provide a step engagement surface 67 that interlocks with corresponding catches 80, 82, 83, 85 of step 40A, 46A when tray 14 is installed on ladder 12. Hanger point 68 is coupled to a distal end of hanger body 66 and is configured to aid both in retaining tray 14 to ladder 12 and removal of tray 14 from ladder 12. In the illustrative embodiment, hanger hook 32 is fixed to tray 14 such that hanger hook 32 does not move relative to tray 14 during installation or removal of tray 14 from ladder 12.

Retainer latch 34 is configured to move relative to tray 14 and hanger hook 32 during installation and removal of tray 14 as shown in FIGS. 7 and 8. Retainer latch 34 includes a latch body 70, a latch connector 76, and a retainer tip 74 as shown in FIG. 6. Latch body 70 is coupled to biasing means 36 via latch connector 76 to allow latch body 70 and retainer tip 74 to move away from hanger hook 32 during installation and removal of tray 14 from ladder 12. Latch connector 76 is a rivet or pin that is coupled to tray 14 in rotating bearing engagement to allow retainer latch 34 to pivot relative to tray 14. Retainer tip 74 is configured to pivot about a latch pivot axis 75 established by latch connector 76 as tray 14 is installed and removed from a step 40A, 46B of ladder 12 as suggested in FIGS. 7 and 8. In the illustrative embodiment, biasing means 36 includes a torsion spring 78 that is wound around latch connector 76 and that applies a force on latch body 70 to urge latch body 70 and retainer tip 74 to pivot toward hanger hook 32.

In the embodiments in which hanger hook 32 is coupled to tray 14 for pivotable movement, hanger hook 32 may be similarly configured as retainer latch 34. In such an embodiment, hanger hook 32 includes a hook connector similar to latch connector 76 and biasing means similar to biasing means 36.

Retainer tip 74 of retainer latch 34 is configured to contact surfaces of a step 40A, 46A during installation and removal of tray 14 from ladder 12 to cause retainer latch 34 to pivot away from hanger hook 32 as shown in FIG. 7. Retainer tip 74 includes a first cam surface 72 and a second cam surface 73 which converge at a point 77 facing toward hanger hook 32 as shown in FIG. 6. First cam surface 72 engages a step 40A, 46A during installation of tray 14. First cam surface 72 is angled relative to the steps 40A, 46A so that engagement between first cam surface 72 and step 40A, 46A causes retainer latch 34 to pivot away from hanger hook 32 as tray 14 is lowered with downward movement 65 onto a step 40A, 46A to be installed. Second cam surface 73 is configured to engage portions of a step 40A, 46A to block movement of tray 14 relative to the step 40A, 46A once tray 14 is installed. Second cam surface 73 is also angled relative to steps 40A, 46A so that a force on tray 14 above a predetermined amount causes retainer latch 34 to pivot away from hanger hook 32 as tray 14 is lifted upwardly away from step 40A, 46A and tray 14 is uninstalled. First and second cam surfaces 72, 73 allow tray 14 to be installed or removed from ladder 12 with only one hand by the user.

In the illustrative embodiment, retainer latches 34 are arranged to lie at least partially in a channel 89 formed by pocket dividers 86 on the underside 54 of tray base 26. Each of the retainer latches 34 are offset inwardly from each hanger hook 32.

Other comparative trays may include fasteners to permanently attach the tray to a ladder or buttons which must be engaged by a user before removal of the tray from the ladder is possible. Mode-independent attachment unit 16 allows tray 14 to be installed and removed from ladder 12 without any fasteners or locks requiring a button to unlock the tray 14 from the ladder 12 before removal from the ladder 12.

By way of example, as shown in FIGS. 7 and 8, hanger hook 32 engages first catch 80 of step 40A while tray 14 is installed by wrapping at least partially around first catch 80. Specifically, step engagement surface 67 of hanger hook 32 engages first catch 80. Retainer latch 34 engages second catch 82 of step 40A while tray 14 is installed by wrapping at least partially around second catch 82. Second catch 82 engages first cam surface 72 while tray 14 is placed on ladder 12 and engages second cam surface 73 after tray 14 is placed on ladder 12. Depending on the orientation of tray 14 on ladder 12, hanger hook 32 may engage second catch 82 and retainer latch may engage first catch 80.

Tray 14 may be similarly placed on step 46A such that hanger hook 32 engages second catch 82 of step 46A and retainer latch 34 engages first catch 80 of step 46A. Similarly, tray 14 may be placed on step 46A such that hanger hook 32 engages first catch 80 of step 46A and retainer latch engages second catch 82 of step 46A.

While ladder 12 is in straight-ladder mode, hanger hook 32 may engage fourth catch 85 of step 40A, 46A and retainer latch 34 may engage third catch 83 of step 40A, 46A, and vice versa. The I-shaped cross section of steps 40A, 46A allows tray 14 to be attached to any step 40A, 46A of ladder 12 regardless of whether ladder 12 is in step-ladder mode or straight-ladder mode. Mode-independent attachment unit 16 is configured to engage two of the four catches 80, 82, 83, 85 of any step 40A, 46A to mount tray 14 to ladder 12. Which two catches 80, 82, 83, 85 are used to mount tray 14 to ladder 12 is dependent on the orientation of each particular step 40A, 46A when ladder 12 is in step-ladder mode or straight-ladder mode.

To attach tray 14 to ladder 12, the user places the underside 54 of tray 14 above the plurality of steps 40A, 46A as suggested in FIG. 3. While pivoting tray 14 in a downward direction with downward movement 65 toward the steps 40A, 46A, retainer latch 34 moves from a normally locked position, as shown in FIG. 8, to a release position, as shown in FIG. 7. Biasing means 36 allows retainer latch 34 to move away from hanger hook 32 and normally urges retainer latch 34 back to the locked position.

Retainer latch 34 moves away from hanger hook 32 when first cam surface 72 contacts one of the plurality of steps 40A, 46A as shown in FIG. 7. Once retainer tip 74 moves past one of the catches 80, 82, 83, 85, biasing means 36 urges retainer latch 34 to move toward hanger hook 32 as shown in FIG. 8. When this occurs, second cam surface 73 of retainer latch 34 fits with one of the catches 80, 82, 83, 85 to establish the normally locked position of retainer latch 34 as shown in FIG. 8. The step engagement surface 67 of hanger hook 32 also fits with one of the catches 80, 82, 83, 85 in this position.

In the normally locked position, at least a portion of retainer latch 34 is spaced from hanger hook 32 a first distance and is configured to block upward and sliding movement of tray 14 relative to ladder 12 as shown in FIG. 8. To remove tray 14 from ladder 12, the user pivots tray 14 upward relative to steps 40A, 46B. During tray 14 detachment, retainer latch 34 is moved to the release position. In the release position, at least a portion of retainer latch 34 is spaced a second distance from hanger hook 32 in response to upward pivoting movement of tray 14 relative to ladder 12 so that retainer latch 34 can clear one of the catches 80, 82, 83, 85 and tray 14 can be removed from ladder 12. The second distance is greater than the first distance, as suggested in FIGS. 7 and 8.

Another embodiment of a ladder system 210 in accordance with the present disclosure is shown in FIGS. 12-22. Ladder system 210 is similar to ladder system 10. Accordingly, similar reference numbers in the 200 series are used to reference common features between ladder system 10 and ladder system 210. The disclosure of ladder system 10 is hereby incorporated by reference herein for ladder system 210 except for the differences discussed herein.

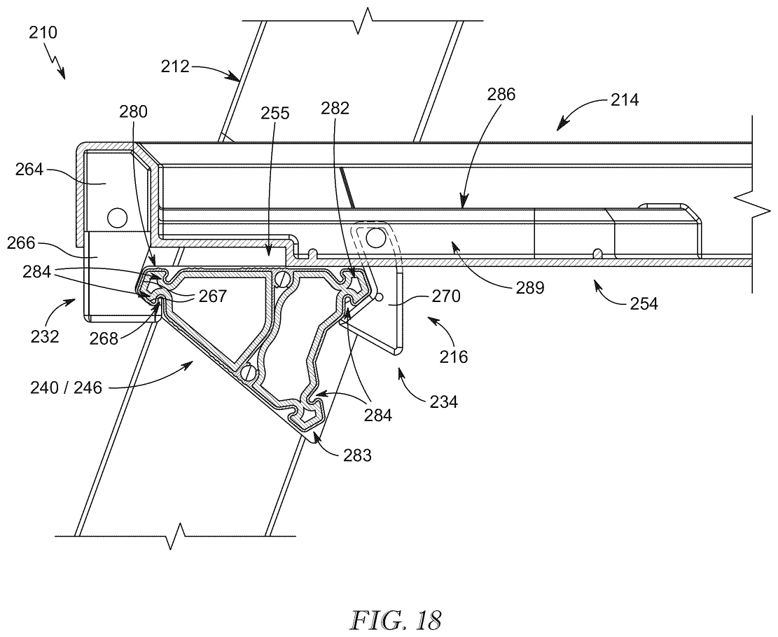

Ladder system 210 includes a ladder 212, a tray 214, and a mode-independent attachment unit 216 as shown in FIGS. 12 and 18. Ladder 212 is configured to support a user above underlying ground so that the user can reach higher areas. Tray 214 is configured to attach to ladder 212 and may be used to support items for the user while the user climbs ladder 212 and accesses the higher areas. Mode-independent attachment unit 216 is configured to mount tray 214 to ladder 212 and allows for one handed removal and installation of tray 214 so that the user can maintain support on ladder 212 with their other hand while climbing ladder 212 and repositioning tray 214.

Ladder 212 includes a first ladder unit 218, a second ladder unit 220, and a mode-changing hinge 222 as shown in FIG. 12. First ladder unit 218 is coupled to mode-changing hinge 222 and extends away from mode-changing hinge 222 in a first direction. Second ladder unit 220 is coupled to mode-changing hinge 222 and extends away from mode-changing hinge 222 in a second direction different than the first direction. Mode-changing hinge 222 interconnects first ladder unit 218 and second ladder unit 220 and provides a horizontal hinge pivot axis 224 to allow an angle between first and second ladder units 218, 220 to be adjusted.

First ladder unit 218 includes a first pair of ladder supports 238, a first plurality of steps 240, and a first pair of braces 242 as shown in FIG. 12. Ladder supports 238 are substantially parallel to one another and are interconnected by first plurality of steps 240. First plurality of steps 240 are configured to support the user while the user climbs ladder 212 and are configured to support tray 214 while tray 214 is in use on ladder 212. Braces 242 support ladder 212 using either the underlying ground or an external surface.

Second ladder unit 220 includes a second pair of ladder supports 244, a second plurality of steps 246, and a second pair of braces 248 as shown in FIG. 12. Ladder supports 244 are substantially parallel to one another and are interconnected by the second plurality of steps 246. The second plurality of steps 246 are configured to support the user while the user climbs ladder 212 and are configured to support tray 214 while tray 214 is in use on ladder 212. Braces 248 support ladder 212 using either the underlying ground or an external surface.

Mode-changing hinge 222 includes a pair of first connectors 250 and a pair of second connectors 252 as shown in FIG. 12. First connectors 250 couple ladder supports 238 to mode-changing hinge 222 while second connectors 252 couple ladder supports 244 to mode-changing hinge 222. First and second connectors 250, 252 allow first ladder unit 218 and second ladder unit 220 to be adjusted about horizontal hinge pivot axis 224 to change ladder 212 between a step-ladder mode, as shown in FIG. 23, and a straight-ladder mode, as shown in FIGS. 12 and 24.

In step-ladder mode, first ladder unit 218 and second ladder unit 220 extend upwardly away from the underlying ground and toward one another to form an included angle therebetween as shown in FIG. 23. Ladder 212 is self-supported in step-ladder mode using braces 242, 248 which both engage the underlying ground to support ladder 212 above the underlying ground. In straight-ladder mode, first ladder unit 218 and second ladder unit 220 are arranged along a substantially straight line such that one of first ladder unit 218 and second ladder unit 220 is supported above the underlying ground when ladder 212 is leaned against a structure. Ladder 212 is supported partially by the structure in straight-ladder mode by planting one of the braces 242, 248 on the underlying ground while the other leans against the structure. First and second ladder units 218, 220 are also adjustable about horizontal hinge pivot axis 224 to place the ladder 212 in a storage mode in which first and second ladder units 218, 220 are arranged to lie in side-by-side and substantially parallel relation to one another as shown in FIG. 14. Mode-changing hinge 222 further includes a lock (not shown) to block selective movement of first connectors 250 relative to second connectors 252 so that ladder 212 maintains step-ladder mode, straight ladder mode, or storage mode.

Tray 214 is configured to be attached to first ladder unit 218 or second ladder unit 220 such that tray 214 may be used by the user while ladder 212 is in either step-ladder mode, as shown in FIG. 23, or straight-ladder mode, as shown in FIG. 12. Tray 214 may extend forwardly or rearwardly on ladder 212. Tray 214 may also be attached to first ladder unit 218 or second ladder unit 220 in a tray-storage mode and may lie along a plane that is substantially parallel to both first and second ladder units 218, 220 so as to minimize a total width of ladder system 210 in storage mode as shown in FIG. 14. Tray 214 may also lie between ladder units 218, 220 in the storage mode. Tray 214 may be placed in tray-storage mode even when ladder 212 is not in storage mode.

Tray 214 is configured to mount to steps 240, 246 of ladder 212 and includes a tray base 226, a tray rim 228, and a tray storage mount 229 as shown in FIG. 13-16. Tray base 226 is arranged to lie substantially horizontally when attached to a step 240, 246 and is configured to support items for the user climbing ladder 212. Tray rim 228 is coupled to a perimeter of tray base 226 and extends upwardly from tray base 226 to ensure that items placed on tray base 226 do not fall off of tray 214. Tray storage mount 229 allows tray 214 to be attached releasably between two neighboring steps 240, 246 in the tray-storage mode as shown in FIG. 14.

Tray base 226 is formed to include one or more raised pocket dividers 286 as shown in FIG. 13. The pocket dividers 286 are configured to establish a plurality of separate item pockets 288 that can each be used to hold and separate different items. Tray base 226 includes an underside 254 and a topside 256 as shown in FIG. 13. Underside 254 of tray base 226 interfaces with the plurality of steps 240, 246 when tray 214 is placed on ladder 212, regardless of whether tray 214 extends forwardly or rearwardly relative to ladder 212. Topside 256 is configured to engage and support items placed on tray 214.

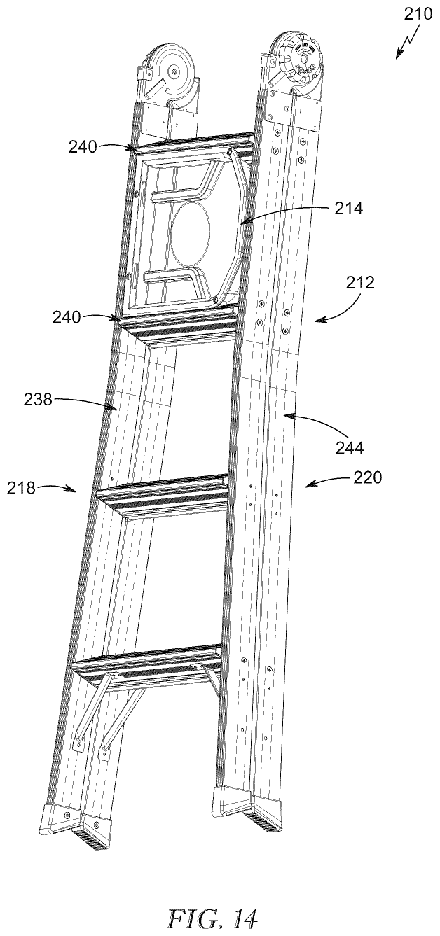

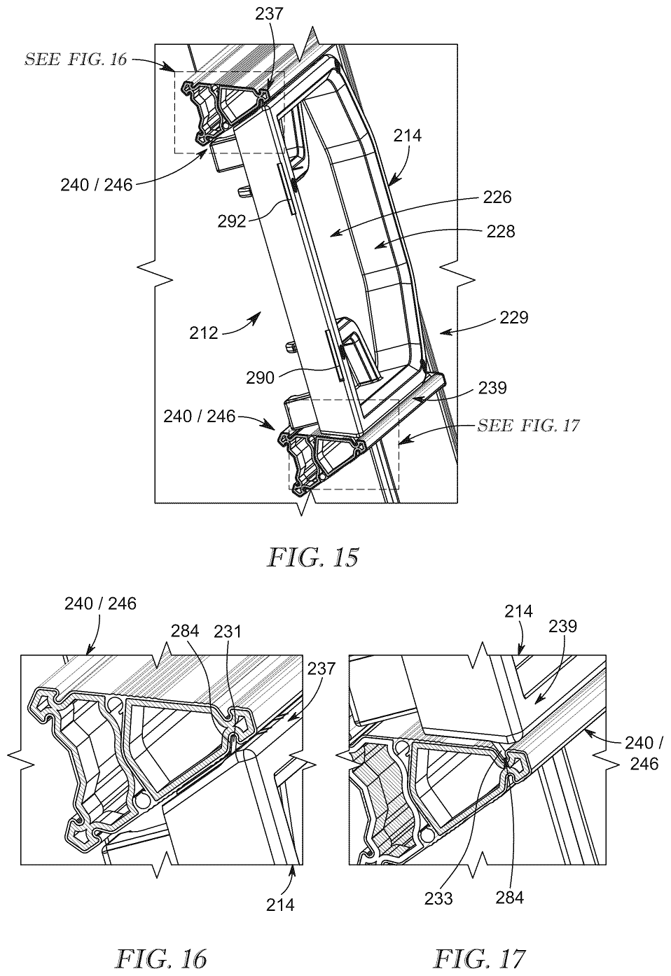

Tray rim 228 is sized to maximize a volume of an item-holding area 235 provided by tray 214 and to correspond to the shape and size of steps 240, 246 and ladder supports 238, 244 as shown in FIGS. 14 and 15. Tray rim 228 includes first and second side walls 237, 239 and front and rear walls 241, 243. A width of tray 214 is defined between first and second side walls 237, 239 and is sized to correspond to spacing between two neighboring steps 240, 246. Likewise, a length of tray 214 is defined by front and rear walls 241, 243 and is sized to correspond to spacing between ladder supports 238, 244. In this way, tray 214 resides in a space located vertically between two steps and laterally between ladder supports 238, 244 in the tray-storage mode. Tray 214 does not protrude outwardly beyond the space in any direction in the storage mode.

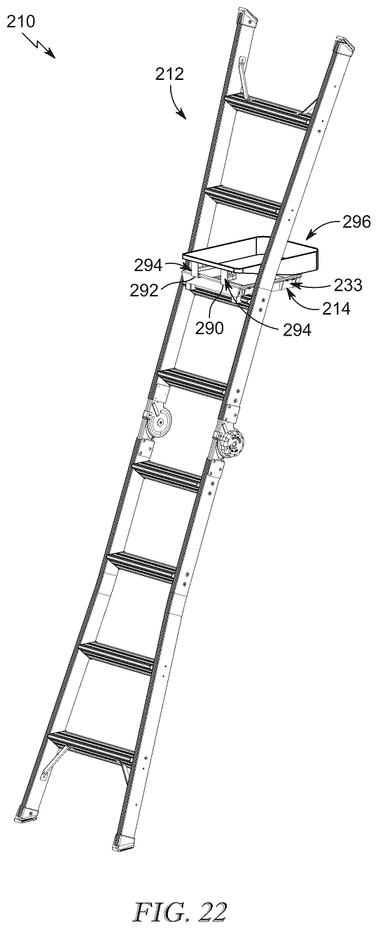

Rear wall 243 of tray rim 228 is formed to include a pair of tray attachment slots 290, 292 as shown in FIGS. 13 and 22. The tray attachment slots 290, 292 are configured to receive attachment hooks 294 included in a paint tray 296. The paint tray 296 may be included in the ladder system 210.

Mode-independent attachment unit 216 is configured to provide a compressive load on a step 240, 246 included in one of first and second ladder units 218, 220 to block movement of tray 214 relative to ladder 212. Mode-independent attachment unit 216 includes a hanger hook 232, a retainer latch 234, and biasing means 236 as shown in FIGS. 18 and 21. Hanger hook 232 is fixed to tray 214 and engages first ladder unit 218 or second ladder unit 220 while tray 214 is in use. Retainer latch 234 is coupled to tray 214 and movable relative to hanger hook 232 and tray 214. Biasing means 236, as shown in FIG. 21, is coupled to retainer latch 234 and urges retainer latch 234 toward hanger hook 232 so that the compressive load is provided on the step 240, 246 by and between hanger hook 232 and retainer latch 234. In the illustrative embodiment, mode-independent attachment unit 216 includes a pair of hanger hooks 232 and a pair of retainer latches 234.

Hanger hook 232 includes a hanger mount 264, a hanger body 266, and a hanger point 268 as shown in FIG. 18. Hanger mount 264 is fixed to at least one of tray base 226 and tray rim 228. Hanger body 266 extends downwardly from hanger mount 264 and toward retainer latch 234 to provide a plurality of step engagement surfaces 267 that interlock with corresponding surfaces of a step 240, 246 when tray 214 is installed on ladder 212. Hanger point 268 is coupled to a distal end of hanger body 266 and is configured to aid both in retaining tray 214 to ladder 212 and removal of tray 214 from ladder 212.

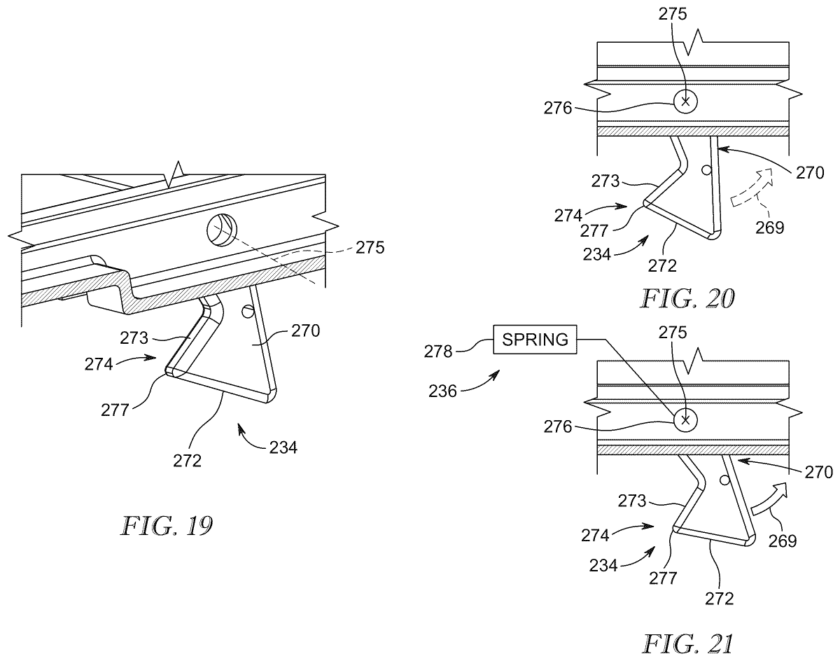

Retainer latch 234 is configured to move relative to tray 214 and hanger hook 232 during installation and removal of tray 214 as suggested in FIGS. 20 and 21. Retainer latch 234 includes a latch body 270, a latch connector 276, and a retainer tip 274 as shown in FIGS. 19-21. Latch body 270 is coupled to biasing means 236 via latch connector 276 to allow latch body 270 and retainer tip 274 to move away from hanger hook 232 during installation and removal of tray 214 from ladder 212. Latch connector 276 is a rivet or pin that is coupled to tray 214 in rotating bearing engagement to allow retainer latch 234 to pivot relative to tray 214. Retainer tip 274 is configured to pivot (see pivoting arrow 269 in FIGS. 20 and 21) about a latch pivot axis 275 established by latch connector 276 as tray 214 is installed and removed from a step 240, 246 of ladder 212 as suggested in FIGS. 20 and 21. In the illustrative embodiment, biasing means 236 includes a torsion spring 278 that is wound around latch connector 276 and that applies a force on latch body 270 to urge latch body 270 and retainer tip 274 to pivot toward hanger hook 232.

In the illustrative embodiment, retainer latches 234 are arranged to lie at least partially in a channel 289 formed by pocket dividers 286 on the underside 254 of tray base 226. Each of the retainer latches 234 are also offset inwardly from each hanger hook 232.

Retainer tip 274 is configured to contact surfaces of a step 240, 246 during installation and removal of tray 214 from ladder 212 to cause retainer latch 234 to pivot away from hanger hook 232. Retainer tip 274 includes a first cam surface 272 and a second cam surface 273 which converge at a point 277 facing toward hanger hook 232 as shown in FIG. 21. First cam surface 272 engages a step 240, 246 during installation of tray 214. First cam surface 272 is angled relative to the steps 240, 246 so that engagement between first cam surface 272 and step 240, 246 causes retainer latch 234 to pivot away from hanger hook 232 as tray 214 is lowered onto a step 240, 246 to be installed. Second cam surface 273 is configured to engage portions of a step 240, 246 to block movement of tray 214 relative to the step 240, 246 once tray 214 is installed. Second cam surface 273 is also angled relative to steps 240, 246 so that a force on tray 214 above a predetermined amount causes retainer latch 234 to pivot away from hanger hook 232 as tray 214 is lifted upwardly away from the step 240, 246 and tray 214 is uninstalled. First and second cam surfaces 272, 273 allow tray 214 to be installed or removed from ladder 212 with only one hand by a user.

Each of the plurality of steps 240, 246 includes a hook catch 280 and a latch catch 282. Hook catch 280 and latch catch 282 are positioned on opposite sides of each step 240, 246 from one another. Hook catch 280 engages with hanger hook 232, specifically the plurality of step engagement surfaces 267, while tray 214 is placed on ladder 212. Latch catch 282 engages with retainer latch 234, specifically first cam surface 272, while tray 214 is placed on ladder 212, and second cam surface 273 once tray 214 is placed on ladder 212. Hook catch 280 may act as latch catch 282 and vice versa depending on the orientation of tray 214 on ladder 212 and the mode of ladder 212.

Each step 240, 246 has an arrowhead-shaped cross section as shown in FIG. 18. This shape provides three catches 280, 282, 283 at each point to the arrowhead-shaped cross section. The arrowhead-shaped cross section allows tray 214 to be attached to any step 240, 246 of ladder 212 regardless of whether ladder 212 is in step-ladder mode or straight-ladder mode. Mode-independent attachment unit 216 is configured to engage two of the catches 280, 282, 283 to mount tray 214 to ladder 212. Which two catches 280, 282, 283 are used to mount tray 214 to ladder 212 is dependent on the orientation of each particular step 240, 246 when ladder 212 is in step-ladder mode or straight-ladder mode.

Each catch 280, 282, 283 is formed to include at least one notch 284 as shown in FIG. 18. In the illustrative embodiment, each catch 280, 282, 283 is formed to include two notches 284. Notches 284 are configured to receive hanger point 268. Engagement between hanger point 268 and notches 284 allows hanger hook 232 to bear loads acting on step 240, 246 from second cam surface 273 during removal of tray 214 so that retainer latch 234 slides relative to tray 214 without tray 214 sliding relative to ladder 212.

To attach tray 214 to ladder 212, the user places underside 254 of tray 214 above the plurality of steps 240, 246. Underside 254 of tray 214 may include a ledge 255. Ledge 255 can extend into a notch 284 during installation to bear loads acting on step 240, 246 from first cam surface 272 during installation of tray 214 so that retainer latch 234 pivots relative to tray 214 without tray 214 sliding relative to ladder 212 during installation.

While pivoting tray 214 in a downward direction toward the plurality of steps 240, 246, retainer latch 234 moves from a normally locked position, as shown in FIG. 20, to a release position, as shown in FIG. 21. Biasing means 236 allows retainer latch 234 to move away from hanger hook 232 and normally urges retainer latch 234 back to the locked position. Hanger hook 232 remains stationary relative to tray 214 while retainer latch 234 moves away from hanger hook 232.

Retainer latch 234 moves away from hanger hook 232 when first cam surface 272 contacts one of the plurality of steps 240, 246 as shown in FIG. 21. Once retainer tip 274 moves past a widest portion of latch catch 282, biasing means 236 urges retainer latch 234 to move toward hanger hook 232 as shown in FIG. 20. When this occurs, the first cam surface 272 of retainer latch 234 fits with latch catch 282 of one of the plurality of steps 240, 246 to establish the normally locked position of retainer latch 234 as shown in FIG. 20. The plurality of step engagement surfaces 267 of hanger hook 232 also fit with hook catch 280 of one of the plurality of steps 240, 246 in this position.

In the normally locked position, at least a portion of retainer latch 234 is spaced from hanger hook 232 a first distance and is configured to block upward and sliding movement of tray 214 relative to ladder 212 as shown in FIG. 18. To remove tray 214 from ladder 212, the user pivots tray 214 upward relative to the plurality of steps 240, 246. During tray 214 detachment, retainer latch 234 is moved to the release position. In the release position, at least a portion of retainer latch 234 is spaced a second distance from hanger hook 232 in response to upward pivoting movement of tray 214 relative to ladder 212 so that retainer latch 234 can clear the widest portion of the step 240, 246 and tray 214 can be removed from ladder 212.

Tray storage mount 229 includes a first rung mount 231 coupled to a first side of tray rim 228 and a second rung mount 233 coupled to an opposite second side of tray rim 228 as shown in FIGS. 15-17. First and second rung mounts 231, 233 are illustratively embodied as ribs that extend outwardly away from tray rim 228 and longitudinally along at least a portion of a length of each respective side of tray rim 228. First and second rung mounts 231, 233 are arranged to extend into notches 284 formed in each neighboring step 240, 246 to temporarily retain tray 214 to ladder 212 in the tray-storage mode as shown in FIG. 14. First and second rung mounts 231, 233 are angled slightly upward relative to the rest of tray 214 to correspond with a shape of notches 284 formed in each step 240, 246. Notches 284 may be sized selectively to correspond to portions of tray 214 and/or mode-independent attachment unit 216 or may be defined by grip features formed on each step 240, 246.

In some embodiments, first and second rung mounts 231, 233 extend along an entirety of the length of each respective side of tray rim 228. In some embodiments, first and second rung mounts 231, 233 are only formed on a portion of each respective side of tray rim 228 as shown in FIGS. 12 and 22. For example, first and second rung mounts 231, 233 may be formed as three ribs 231, 233 that extend outwardly away from tray rim 228 and are each spaced apart from one another along the respective side of tray rim 228. Though shown as three ribs 231, 233 on each respective side of tray rim 228 in FIGS. 12 and 22, any number of ribs 231, 233 is contemplated.

Each step 240, 246 of ladder 212 has upper and lower surfaces which are angled so that the upper surface of each step 240, 246 is arranged to lie substantially horizontally relative to the underlying ground when ladder 212 is in both straight-ladder mode and step-ladder mode as shown in FIG. 18. Each side wall 237, 239 of the tray rim 228 is also angled so that portions of each side wall 237, 239 match an upper surface of one step 240, 246 and a lower surface of a neighboring step 240, 246 when tray 214 is in the tray-storage mode as shown in FIG. 15. At least a portion of side walls 237, 239 interface and are parallel with each corresponding upper and lower surface of the neighboring steps 240, 246 as shown in FIGS. 16 and 17.

Another embodiment of a tray 314 that can be used with ladder system 210 is shown in FIGS. 23-29D. Tray 314 is similar to tray 214 and to tray 14. Accordingly, similar reference numbers in the 300 series are used to reference common features between tray 314, tray 214, and tray 14. The disclosure of tray 214 and tray 14 is hereby incorporated by reference herein for tray 314 except for the differences discussed herein.

Another embodiment of a mode-independent attachment unit 316 that can be used with ladder system 210 and tray 314 is shown in FIGS. 23-29D. Mode-independent attachment unit 316 is similar to mode-independent attachment unit 216 and to mode-independent attachment unit 16. Accordingly, similar reference numbers in the 300 series are used to reference common features between mode-independent attachment unit 316, mode-independent attachment unit 216, and mode-independent attachment unit 16. The disclosure of mode-independent attachment unit 216 and mode-independent attachment unit 16 is hereby incorporated by reference herein for mode-independent attachment unit 316 except for the differences discussed herein.

Tray 314 is configured to attach to ladder 212 and may be used to support items for the user while the user climbs ladder 212 and accesses the higher areas. Tray 314 includes a tray base 326 and a tray rim 328 as shown in FIG. 25. Tray base 326 supports items for the user. Tray rim 328 is coupled to a perimeter of tray base 326 and extends upwardly from tray base 326 to ensure that items placed on tray base 326 do not fall off of tray 314.

Tray 314 is configured to be attached to first ladder unit 218 or second ladder unit 220 such that tray 314 may be used by the user while ladder 212 is in either step-ladder mode, as shown in FIG. 23, or straight-ladder mode, as shown in FIG. 24. Tray 314 may extend forwardly or rearwardly on ladder 212. Tray 314 may also be attached to first ladder unit 218 or second ladder unit 220 in a tray-storage mode and may lie along a plane that is substantially parallel to both first and second ladder units 218, 220 so as to minimize a total width of ladder system 310 in the tray-storage mode as shown in FIG. 14. Tray 314 may also lie between ladder units 218, 220 in the tray-storage mode.

Tray base 326 includes an underside 354 and a topside 356 as shown in FIGS. 25-27. Underside 354 of tray base 326 interfaces with the plurality of steps 240, 246 when tray 314 is placed on ladder 212, regardless of whether tray 314 extends forwardly or rearwardly relative to ladder 212. Topside 356 is configured to engage and support items placed on tray 314.

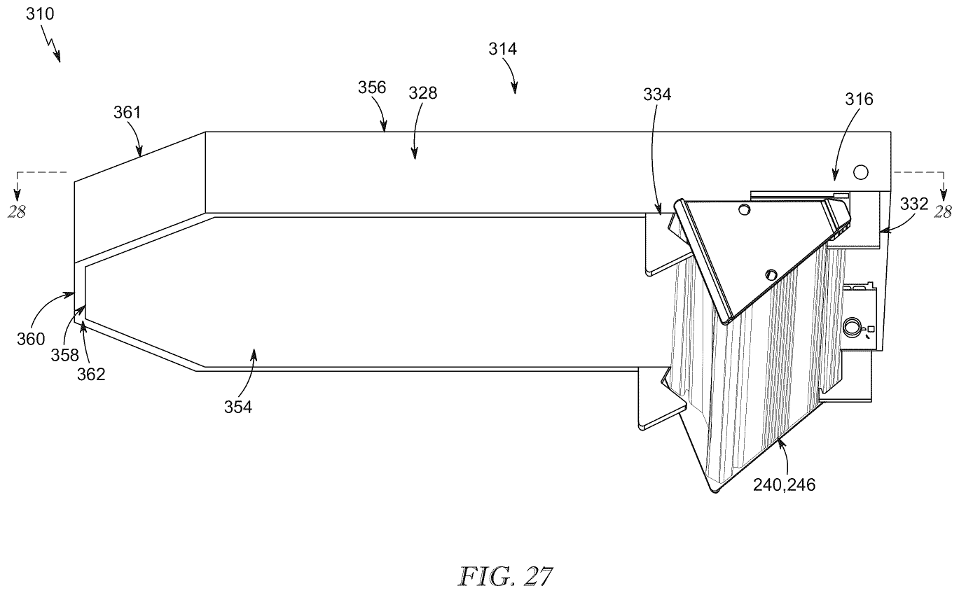

Tray rim 328 includes an inner side wall 358, an outer side wall 360, and a top wall 361 interconnecting upper ends of the inner side wall 358 and the outer side wall 360 as shown in FIG. 27. Inner side wall 358 is spaced apart from outer side wall 360 to provide an interior cavity 362 therebetween. At least a portion of mode-independent attachment unit 316 is received in interior cavity 362.

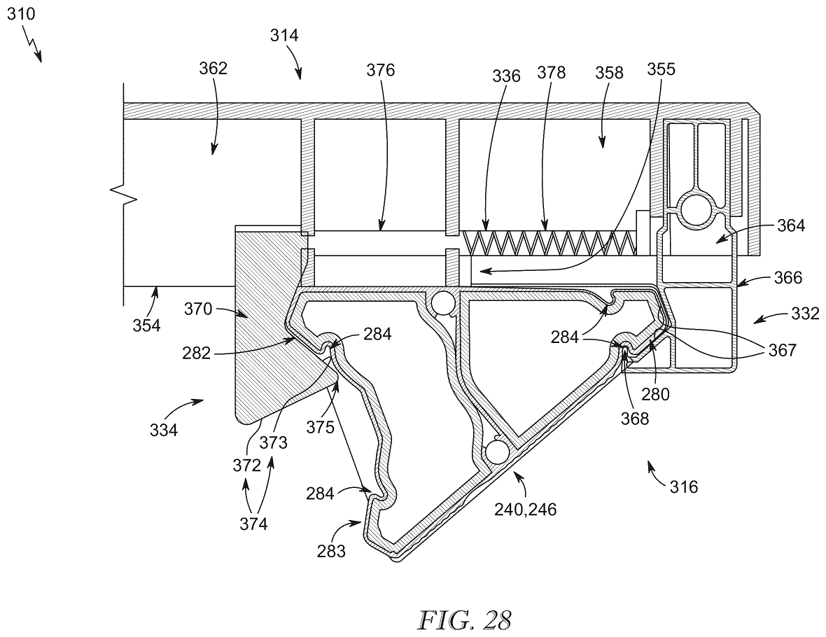

Mode-independent attachment unit 316 is configured to mount tray 314 to ladder 212 and allows for one handed removal and installation of tray 314 so that the user can maintain support on ladder 212 with their other hand while climbing ladder 212 and repositioning tray 314. Mode-independent attachment unit 316 is configured to provide a compressive load on a step 240, 246 included in one of first and second ladder units 218, 220 to block movement of tray 314 relative to ladder 212. Mode-independent attachment unit 316 includes a hanger hook 332, a retainer latch 334, and biasing means 336 as shown in FIGS. 24 and 25. Hanger hook 332 is fixed to tray 314 and engages first ladder unit 218 or second ladder unit 220 while tray 314 is in use. Retainer latch 334 is coupled to tray 314 and movable relative to hanger hook 332 and tray 314. Biasing means 336, as shown in FIG. 28, is coupled to retainer latch 334 and urges retainer latch 334 toward hanger hook 332. When tray 314 is installed, the compressive load is provided on the step 240, 246 by and between hanger hook 332 and retainer latch 334.

Hanger hook 332 includes a hanger mount 364, a hanger body 366, and a hanger point 368 as shown in FIG. 28. Hanger mount 364 is fixed to at least one of tray base 326 and tray rim 328 and is partially received in interior cavity 362 as shown in FIG. 28. Hanger body 366 extends downwardly from hanger mount 364 and toward retainer latch 334 to provide a plurality of step engagement surfaces 367 that interlock with corresponding surfaces of a step 240, 246 when tray 314 is installed on ladder 212. Hanger point 368 is coupled to a distal end of hanger body 366 and is configured to aid both in retaining tray 314 to ladder 212 and removal of tray 314 from ladder 212.

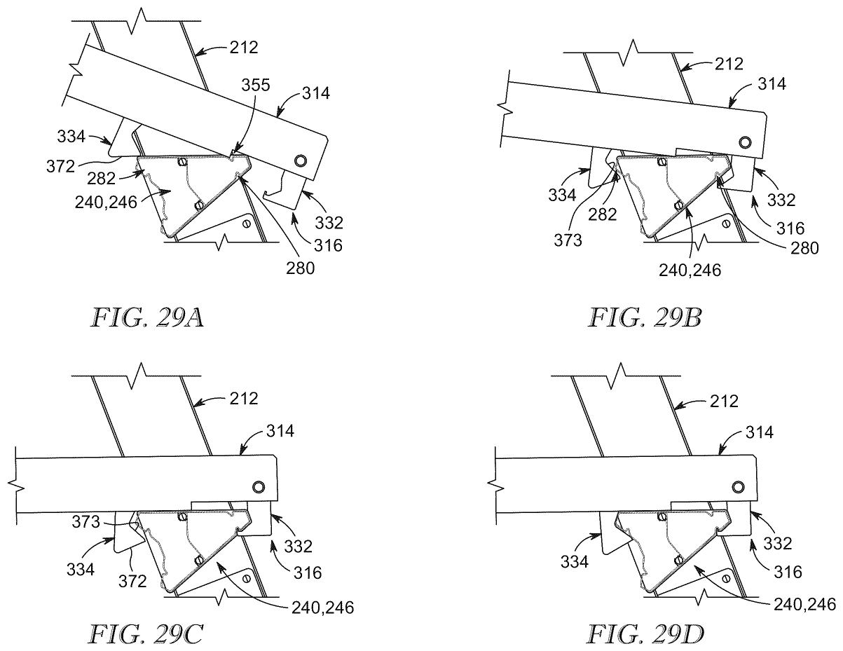

Retainer latch 334 is arranged to lie partially within interior cavity 362 and is configured to move relative to tray 314 and hanger hook 332 during installation and removal of tray 314 as shown in FIGS. 29A-29D. Retainer latch 334 includes a latch body 370, a latch connector 376, and a retainer tip 374 as shown in FIGS. 27 and 28. Latch body 370 is coupled to biasing means 336 via latch connector 376 to allow latch body 370 and retainer tip 374 to move away from hanger hook 332 during installation and removal of tray 314 from ladder 212. Latch connector 376 is arranged to lie in interior cavity 362 and extends toward hanger hook 332 to engage biasing means 336. Retainer tip 374 is configured to contact surfaces of a step 240, 246 during installation and removal of tray 314 from ladder 212 to cause retainer latch 334 to move away from hanger hook 332.

Retainer tip 374 includes a first cam surface 372 and a second cam surface 373 which converge at a point 375 facing toward hanger hook 332 as shown in FIG. 28. First cam surface 372 engages a step 240, 246 during installation of tray 314. First cam surface 372 is angled relative to the steps 240, 246 so that engagement between first cam surface 372 and step 240, 246 causes retainer latch 334 to slide away from hanger hook 332 as tray 314 is pivoted downwardly with downward movement 365 to be installed. Second cam surface 373 is configured to engage portions of a step 240, 246 to block movement of tray 314 relative the step 240, 246 once tray 314 is installed. Second cam surface 373 is also angled relative to steps 240, 246 so that a force on tray 314 above a predetermined amount causes retainer latch 334 to slide away from hanger hook 332 as tray 314 is pivoted upwardly relative to the step 240, 246. First and second cam surfaces 372, 373 allow tray 314 to be installed or removed from ladder 212 with only one hand by a user.

Hook catch 280 of steps 240, 246 engages with hanger hook 332, specifically the plurality of step engagement surfaces 367, while tray 314 is placed on ladder 212 as shown in FIG. 29D. Latch catch 282 of steps 240, 246 engages with retainer latch 334, specifically first cam surface 372, while tray 314 is placed on ladder 212 as shown in FIG. 29A, and second cam surface 373 once tray 314 is placed on ladder 212 as shown in FIG. 29C. Hook catch 280 may act as latch catch 282 and vice versa depending on the orientation of tray 314 on ladder 212.

The arrowhead-shaped cross section of steps 240, 246 allows tray 314 to be attached to any step 240, 246 of ladder 212 regardless of whether ladder 212 is in step-ladder mode or straight-ladder mode. Mode-independent attachment unit 316 is configured to engage two of the catches 280, 282, 283 to mount tray 314 to ladder 212. Which two catches 280, 282, 283 are used to mount tray 314 to ladder 212 is dependent on the orientation of each particular step 240, 246 when ladder 212 is in step-ladder mode or straight-ladder mode.

Notches 284 of steps 240, 246 are configured to receive hanger point 368 as shown in FIG. 29D. Engagement between hanger point 368 and surfaces defining notches 284 allows hanger hook 332 to bear loads acting on step 240, 246 from second cam surface 373 during removal of tray 314 so that retainer latch 334 slides relative to tray 314 without tray 314 sliding relative to ladder 212.

A series of views showing attachment of tray 314 to ladder 212 using mode-independent attachment unit 316 is illustrated in FIGS. 29A-29D. To attach tray 314 to ladder 212, the user places underside 354 of tray 314 above the plurality of steps 240, 246. Underside 354 of tray 314 may include a ledge 355 which can extend into a notch 284 during installation to bear loads acting on step 240, 246 from first cam surface 372 during installation of tray 314 so that retainer latch 334 slides relative to tray 314 without tray 314 sliding relative to ladder 212 during installation as shown in FIG. 29A.

While pivoting tray 314 in a downward toward the plurality of steps 240, 246, retainer latch 334 moves from a normally locked position to a release position as shown in FIG. 29A. Biasing means 336 allows retainer latch 334 to move away from hanger hook 332 and normally urges retainer latch 334 back to the locked position. Hanger hook 332 remains stationary relative to tray 314 while retainer latch 334 moves away from hanger hook 332.

Retainer latch 334 moves away from hanger hook 332 when first cam surface 372 contacts one of the plurality of steps 240, 246 as shown in FIG. 29A. Once retainer tip 374 moves past a widest portion of latch catch 282, biasing means 336 urges retainer latch 334 to move toward hanger hook 332 as shown in FIGS. 29B and 29C. When this occurs, the second cam surface 373 of retainer latch 334 fits with latch catch 282 of one of the plurality of steps 240, 246 to establish the normally locked position of retainer latch 334 as shown in FIG. 29D. The plurality of step engagement surfaces 367 of hanger hook 332 also fit with hook catch 280 of one of the plurality of steps 240, 246 in this position.

In the normally locked position, retainer latch 334 is spaced from hanger hook 332 a first distance and is configured to block upward and sliding movement of tray 314 relative to ladder 212 as shown in FIG. 29D. To remove tray 314 from ladder 212, the user pivots tray 314 upward relative to the plurality of steps 240, 246. During tray 314 detachment, retainer latch 334 is moved to the release position as shown in FIG. 29A. In the release position, retainer latch 334 is spaced a second distance from hanger hook 332 in response to upward pivoting movement of tray 314 relative to ladder 212 so that retainer latch 334 can clear the widest portion of the step 240, 246 and tray 314 can be removed from ladder 212. FIG. 28 shows biasing means 336 while retainer latch 334 is in normally locked position.

Biasing means 336 includes a spring 378, as shown in FIG. 28. Spring 378 urges retainer latch 334 to move relative to tray 314 and toward hanger hook 332. In the illustrative embodiment, a compression spring is arranged to lie between a portion of tray rim 328 and latch connector 376 to provide a compressive load therebetween and to cause retainer latch 334 to slide relative to tray 314 and hanger hook 332. However, in other embodiments, another type of biasing means, such as a tension spring a torsion spring, a leaf spring, or any other suitable resilient member may be used.

The trays 14, 214, 314 discloses herein may be used with any ladder 12, 212, Likewise, the mode-independent attachment units 16, 216, 316 may be used with any tray 14, 214, 314 and any ladder 12, 212.

1. A ladder system comprising:
a ladder including a first ladder unit, a second ladder unit, and a mode-changing hinge interconnecting the first ladder unit and the second ladder unit, the first ladder unit and the second ladder unit each coupled to the mode-changing hinge for pivotable movement relative to one another about a hinge pivot axis to change the ladder from a step-ladder mode, in which the first ladder unit and the second ladder unit extend upwardly away from underlying ground and toward one another to form an included angle therebetween, and a straight-ladder mode, in which the first ladder unit and the second ladder unit are arranged along a substantially straight line such that one of the first ladder unit and the second ladder unit is supported above the underlying ground when the ladder is leaned against a structure,
a tray configured to be attached to the first ladder unit or the second ladder unit, and
an attachment unit configured to detachably couple the tray to a step included in the first ladder unit or the second ladder unit to fix the tray relative to the ladder in a tray-use mode in which the tray lies in plane parallel to the underlying ground when the ladder is in the step-ladder mode to support items thereon and a tray-storage mode in which the tray lies between two neighboring steps in plane with the first ladder unit or the second ladder unit, the attachment unit including a hanger hook coupled to the tray and a retainer latch movable relative to the tray between a normally locked position in which at least a portion of the retainer latch is spaced a first distance from a center point of the tray and configured to block movement of the tray relative to the ladder and a release position in which the at least a portion of the retainer latch is spaced a second distance from the center point of the tray different from the first distance so that the tray is detachable from the ladder.

2. The ladder system of claim 1, wherein the hanger hook includes a hanger mount coupled to the tray, a hanger body extending downwardly from the hanger mount and toward the retainer latch, and a hanger point coupled to a distal end of the hanger body and configured to engage the step.

3. The ladder system of claim 1, wherein the retainer latch includes a latch body extending downwardly from the tray and a retainer tip extending from the latch body, the retainer tip having a first cam surface, a second cam surface, and a latch point formed at a convergence of the first cam surface and the second cam surface.

4. The ladder system of claim 3, wherein the first cam surface faces away from the tray and the second cam surface faces toward the tray, the first cam surface engages the step during installation of the tray onto the step to cause the retainer latch to move away from the step in response to a downward movement of the tray and the second cam surface engages the step to block movement of the tray relative to the step once the tray is installed.

5. The ladder system of claim 4, wherein the first cam surface is angled relative to the step so that engagement between the first cam surface and the step causes the retainer latch to slide relative to the tray as the tray moves downwardly to be installed on the step.

6. The ladder system of claim 1, wherein the tray includes a tray base and a tray rim coupled to a perimeter of the tray base and extending upwardly from the tray base.

7. The ladder system of claim 6, wherein the tray rim includes an inner side wall, an outer side wall spaced apart from the inner side wall, and a top wall interconnecting upper ends of the inner side wall and the outer side wall, and wherein the inner side wall and the outer side wall cooperate to provide an interior cavity therebetween.

8. The ladder system of claim 7, wherein at least a portion of the attachment unit is received in the interior cavity.

9. The ladder system of claim 1, wherein the first ladder unit includes a first set of ladder supports and corresponding first steps interconnecting the first set of ladder supports and a second set of ladder supports and corresponding second steps interconnecting the second set of ladder supports, the second set of ladder supports coupled to the first set of ladder supports for slidable movement relative to the first set of ladder supports to change the first ladder unit from a retracted configuration, in which first braces of the first set of ladder supports and second braces of the second set of ladder supports engage the underlying ground, and an extended configuration, in which the second set of ladder supports slides downwardly relative to the first set of ladder supports such that the second braces of the second set of ladder supports engages the underlying ground and the first braces of the first set of ladder supports are above the underlying ground to increase a height of the first ladder unit.

10. The ladder system of claim 1, wherein the attachment unit includes biasing means configured to urge the retainer latch to the normally locked position.

11. The ladder system of claim 10, wherein the biasing means includes a spring that urges the retainer latch to move relative to the tray.

12. The ladder system of claim 11, wherein the spring is a compression spring.

13. The ladder system of claim 11, wherein the spring allows for linear movement of the retainer latch relative to the tray.

14. A method comprising:
providing a ladder having a first ladder unit, a second ladder unit, and a mode-changing hinge interconnecting the first ladder unit and the second ladder unit,
pivoting the first ladder unit relative to the second ladder unit about the mode-changing hinge to change the ladder to a step-ladder mode,
moving a tray downwardly toward a step of the first ladder unit or the second ladder unit,
in response to engagement of a retainer latch coupled to the tray with the step, moving the retainer latch relative to the tray so that at least a portion of the retainer latch is spaced a first distance from a center point of the tray,
moving the retainer latch relative to the tray so that the at least a portion of the retainer latch is spaced a second distance from the center point of the tray, the second distance being different from the first distance, and
blocking movement of the tray relative to the step while the at least a portion of the retainer latch is spaced the second distance from the center point of the tray such that the tray lies in a horizontal orientation substantially parallel to underlying ground.

15. The method of claim 14, further comprising, after the step of blocking, moving the retainer latch relative to the tray so that the at least a portion of the retainer latch is spaced the first distance from the center point of the tray and moving the tray upwardly away from the step.

16. The method of claim 15, further comprising storing the tray between two neighboring steps of the first ladder unit or the second ladder unit such that the tray lies in plane with the first ladder unit or the second ladder unit.

17. The method of claim 14, wherein the step of moving the retainer latch relative to the tray so that at least a portion of the retainer latch is spaced a first distance from a center point of the tray includes engaging the step with a cam surface of the retainer latch that faces away from the tray to cause the at least a portion of the retainer latch to move relative to the tray so that the at least a portion of the retainer latch is spaced the first distance from the center point of the tray.

18. The method of claim 14, wherein the step of moving the retainer latch relative to the tray so that at least a portion of the retainer latch is spaced a first distance from a center point of the tray includes sliding the retainer latch linearly relative to the tray.

19. The method of claim 14, wherein the step of moving the retainer latch relative to the tray so that the at least a portion of the retainer latch is spaced a second distance from the center point of the tray includes urging the retainer latch to be spaced the second distance from the center point of the tray via a spring.

20. A ladder system comprising:
a ladder including a first ladder unit, a second ladder unit, and a mode-changing hinge interconnecting the first ladder unit and the second ladder unit, the first ladder unit and the second ladder unit each coupled to the mode-changing hinge for pivotable movement relative to one another about a hinge pivot axis to change the ladder from a step-ladder mode, in which the first ladder unit and the second ladder unit extend upwardly away from underlying ground and toward one another to form an included angle therebetween, and a straight-ladder mode, in which the first ladder unit and the second ladder unit are arranged along a substantially straight line such that one of the first ladder unit and the second ladder unit is supported above the underlying ground when the ladder is leaned against a structure,
a tray configured to be attached to the first ladder unit or the second ladder unit, and
an attachment unit configured to detachably couple the tray to a step included in the first ladder unit or the second ladder unit to fix the tray relative to the ladder in a horizontal orientation substantially parallel to the underlying ground when the ladder is in the step-ladder mode or the straight-ladder, the attachment unit including a hanger hook coupled to the tray and a retainer latch movable relative to the tray between a normally locked position in which at least a portion of the retainer latch is spaced a first distance from a center point of the tray and configured to block movement of the tray relative to the ladder and a release position in which the at least a portion of the retainer latch is spaced a second distance from the center point of the tray different from the first distance so that the tray is detachable from the ladder.
